(19) United States
(12) Patent Application Publication
(10) Pub. No.: US 2006/0125203 A1
(43) Pub. Date: Jun. 15, 2006

(54) Trailer alignment bracket (TAB)

(76) Inventor: James Davis JR., Chanute, KS (US)

Correspondence Address: James Davis, Jr., 1328 West Cherry Street, Chanute, KS, 66720, US

(21) Appl. No.: 10/799,985

(22) Filed: Mar. 12, 2004

(51) Int. Cl. B60G 11/10; B60G 7/00

(52) U.S. Cl. 280/124.175; 280/124.17

(57) ABSTRACT

The Trailer Alignment Bracket (TAB) system is a new concept to aligning any type of trailer. The TAB brackets are made with ⅜ inch to ⅝ inch steel, using Grade 10 bolts. The TAB system consist of 3 different specially designed brackets fitting on trailer framer in front, middle and rear of axles. The Brackets are made to be adjustable so that the original spring brackets welded stationary to frame at assembly point, are removed and TAB is installed after measuring mis-alignment. When trailer is re-assembled, again the alignment is checked for correct settings using computerized laser equipment. This system does provide positive tire performance, saves fuel and adds a very positive element in entire towing operation.

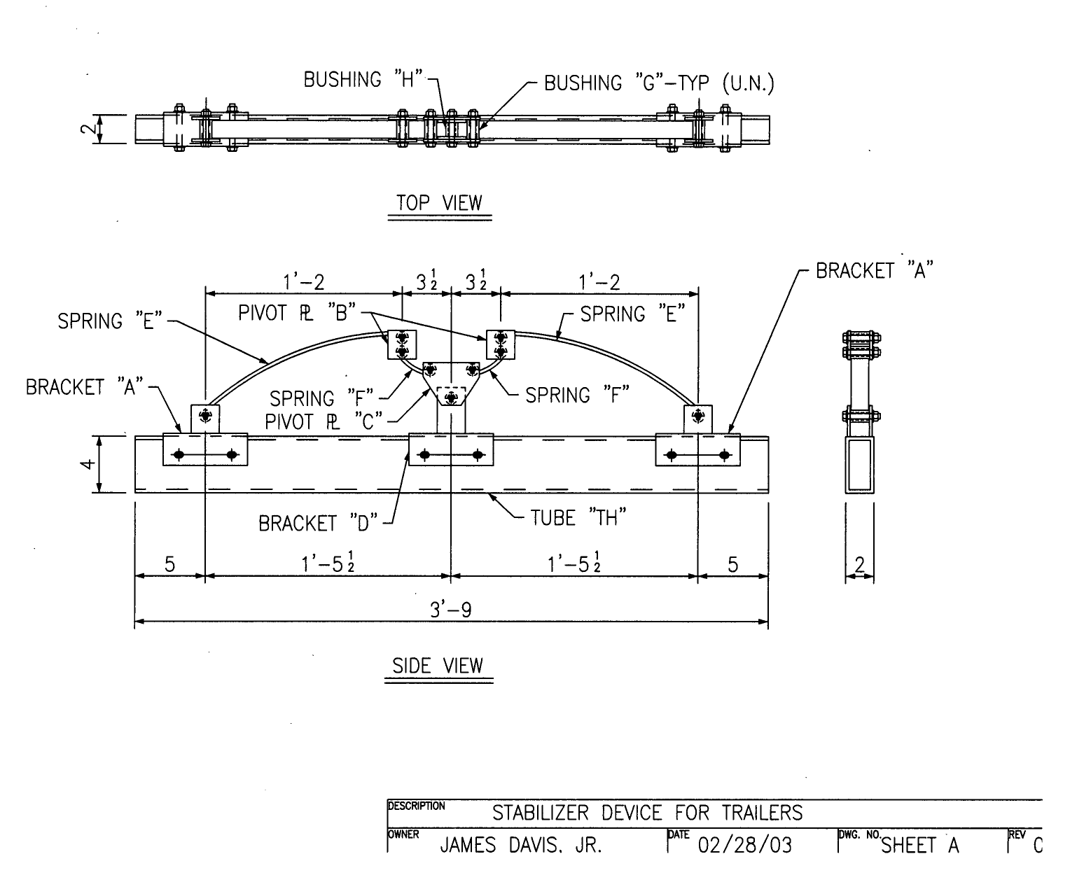

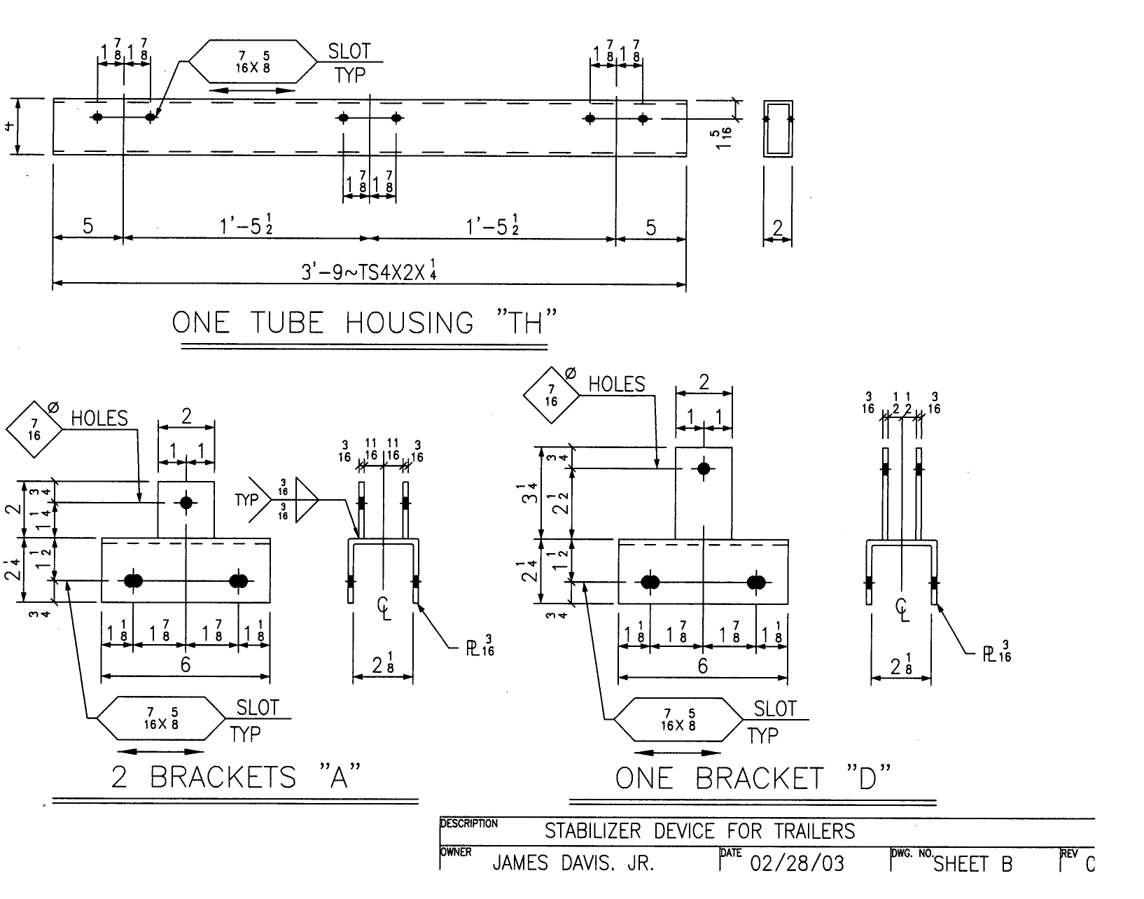

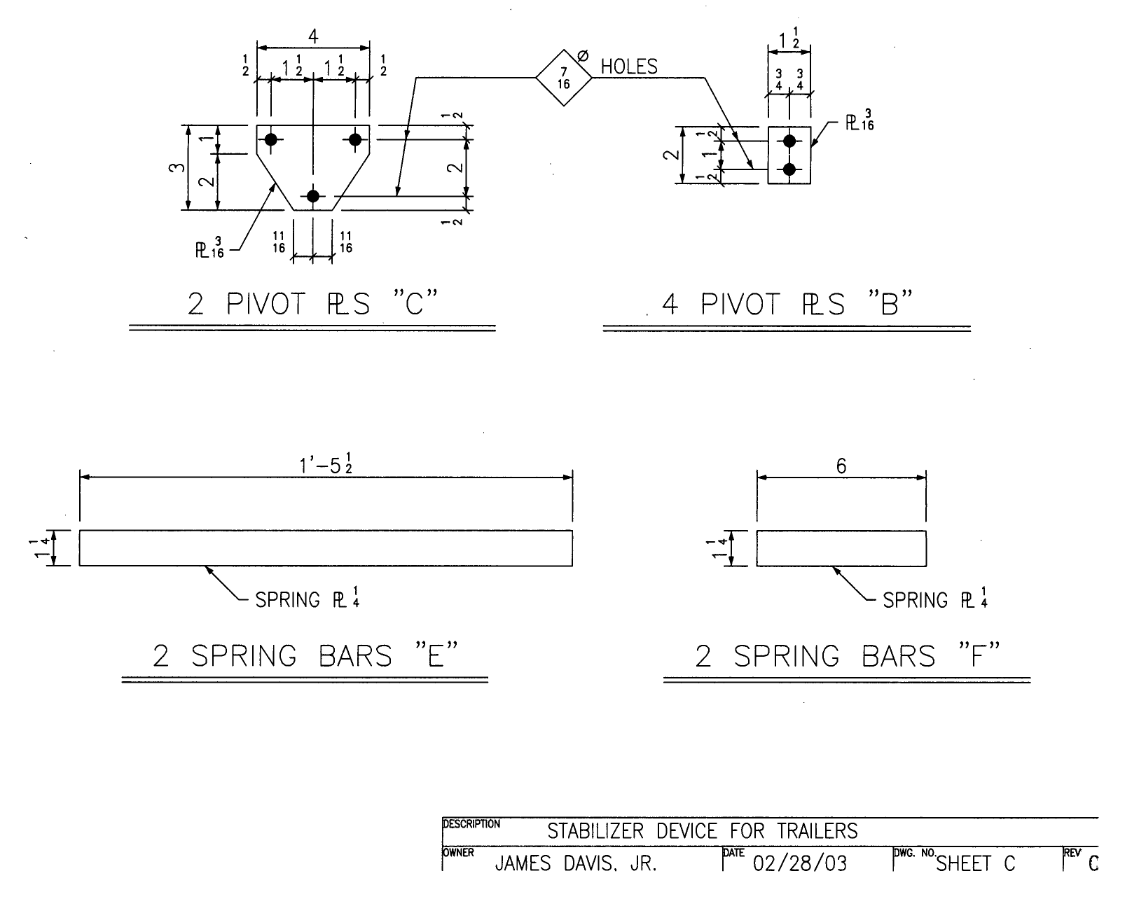

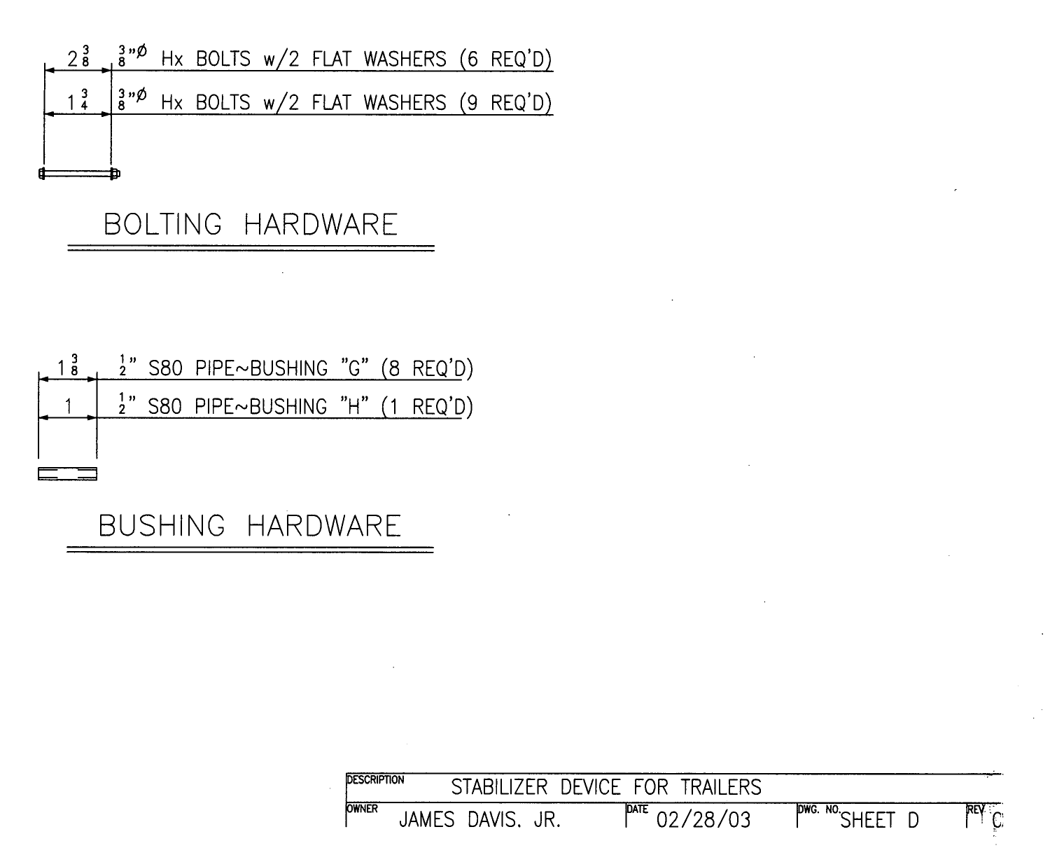

This is the Application Data Sheet

I. This is a Utility Patent pending application transmittal letter. We are following instructions from the patent manual.

II. The Owner of this Utility Patent Pending (status) is Jim Davis, Cherry and Plummer Streets, Chanute, Kans. 66720 Phone # 620.432.0068

III. To the best of his knowledge, Mr. Davis is requesting a utility patent pending From the U.S. Patent office.

IV. The Name of this product that he is requesting a patent on is called a Trailer Alignment Bracket (TAB).

V. The TAB will, when installed on any existing new or used trailer, maintain a near perfect alignment behind towing vehicle. These types of trailers include campers, utility trailer, horse trailer, etc.

VI. The applicant has to the best of his ability and knowledge, has researched and Developed this product according to the most intensive safety requirements he understands. He has made various prototypes to develop this product.

VII The applicant has included with this statement letter, a history of why this Product is very necessary in regard to public and individual safety. And by Utilizing this product in keeping trailers in alignment with tow vehicle, it will Save our natural resources of fuel, tire material and man made equipment.

VIII This application includes actual photos and mechanical drawings to identify TAB. These materials identify the individual parts.

IX The applicant has submitted requested fees for a Utility Patent Pending Application

The Specification of this Product

I. The TAB is installed onto any existing trailer frame that has leaf springs. It is bolted to the main frame of the trailer so that the bracket can be adjusted over the trailers axes to ensure the trailer is towed directly behind the tow vehicle. There are basically 12 individual parts held together with ⅜ inch bolts, 12 nylon and steel bushings and clamped with nylon nuts. There are three individual brackets that can be adjusted to bring tolerance of trailer to exact towing alignment.

Owner of Title

I. Jim Davis of Cherry and Plummer St., Chanute, Kansas, 66720, claims and reserves all rights and guarantees to the ownership of the Trailer Alignment Bracket (TAB) as stated forth by the U.S. Patent Office under the Congressional laws of the United States of America.

History

I. In developing this product (TAB) this applicant studied the history of trailer Alignment and found many serious negative variables that were and are currently causing major problems with equipment and safety to our highways. After many years in management of tire service, he found number impact areas that need to be addressed. One major element was tire situations. Another was trailer manufacturing and assembly.

Title

I. The title of this product will be Trailer Alignment Bracket (TAB).

II. Mr. James Davis, Jr. claims all rights the Trailer Alignment Bracket and claims protection of his invention stipulated by the U.S. government. He lays claim to (TAB) by his own design and reserves the right to modify his product to ensure a standard of quality in his product.

III. Developing the history of the TAB, it was found that there were many serious problems with trailer alignment throughout the industry of trailers. Mr. Davis took a serious look at trailers in toll and developed the product by understanding the problems that affect trailers.
A. All trailers require various types of tires, axes, frames, etc. He addressed the tires to begin with. He found that tire-rolling resistance was the major effect on fuel consumption.
   1. Tire rolling resistance per gallon of fuel equals approx. 42.2%
   2. Drive train of the vehicle uses approx. 16.0%
   3. The combination of vehicle (cab) and Trailer design or Aerodynamic drag equals approx. 34.6%
   4. Cab fan and accessories (power steering, AC, etc.) 7.2%
B. Approx. 0.053 inches or the width of a dime difference in true alignment causes thousands of dollars of damage to the rear of cabs and to trailers. Although thousands of dollars are spent toward more powerful motors, streamlining bodywork and improving drive trains, they do not improve the safety of the operation of pulling trailers.
C. It is a fact that all manufactures design trailers to be within a ⅛ inch to ¼ inch tolerance. The ideal alignment for safe tolling is 1/16 inch. An assessment of being out of tolerance concludes that most people leave the trailer alone, they repair the trailer somehow or they replace the axle.
   1. The inventor of the TAB describes the damage caused with tolling of the trailer out of alignment by suing a formula for tire deterioration.
      A. Circumference=Diameter×3.14
      B. One degree=Circumference=360 degrees
      C. Federal Dept. of Transportation regulation for wheel width maximum is 96 inches . . . .
         a. 96 inches×3.14 301.44 inches/360 degrees=0.837 or 1
         degree=0.840
         ½ degree out of line equals=0.420
         ¼ degree out of line equals=0.201
         ⅛ degree out of line equals=0.105
         1/16 degree out of line equals=0.0525
         b. There are 5,280 feet in a mile×3.14=16,579 ft. 16,579 ft/360
         Degrees=460 ft. or 1 degree=46 ft.
         ½ degree out of line equals=23 ft.
         ¼ degree put of line equals=11.5 ft
         ⅛ degree out of line equals=6 ft
         1/16 degree out of line equals=less than ½ inch
         c. A ⅛ degree thrust angle (0.13) is 6 foot and give an annual travel
         Mileage of 125,000, a trailer will scrub its tires 750,000 or 142 miles off of its tire tread. Note: The average truck has a thrust angle of 0.30-0.40 inches.
         d. The OEM specifications require the typical rear axle alignment as Described.
         a. The front tandem axle shall be perpendicular to the frame rail
         (+) or (−) ⅛ inch or (0.125)
         b. The rear tandem axle shall be parallel to the front tandem axle
         (+) or (−) ⅛ inch or (0.125)
         e. In researching random of 3 different manufactures, it was found That the usage of tolerances was twice as wide + or −¼ inch. This inventor believes and understands that a tolerance should Be+ or − 1/32 inches to ensure tire wear and safety along with Safe guarding axles, trailer framing and even brakes.
         f. To Summarize this history, the inventory feels that this product Will eliminate certain tire wear situations and problems.

VII. Summary

The (TAB) will be installed on any type of pulled trailer that has leaf springs. This will ensure that the trailer alignment will be within the 1/16 inch tolerance while being pulled. The (TAB) is designed with adjustment holes to ensure quality installation. It will save wear and tear on existing trailer framing, brakes and axles. It will keep the trailer directly behind the toll vehicle, which will ensure safety. Also, it will eliminate all severe tire wear. And it will save fuel to the consumer by streamlining the cab & trailer moving down the road. The (TAB) is a group of purposely made steel brackets, steel bars, nylon bushings, bolts and nuts formed to such a matter that it weighs less than 10 lbs and is approx. four feet long by one foot high. There are 10 different pieces that are assembled together to make this product.

### VIII. DETAILED DESCRIPTION

The (TAB) is made of Grade 8 steel. The bracket pieces are made of ⅜ inch steel and cut to form by a panel master machine. This machine runs from a computer tape and ensures all measurements to be exact. The pieces are formed and bent into shape. Some pieces are connected to each other with #10 stick welding rods. High quality bolts, self-locking nuts and top quality nylon bushings are used. Each part is measure to blue print standard, examined and tested for quality assurance. Each step of the assembly is double-checked to be in exact specification of blue print design.

1. What I claim as my invention is metal alignment trailer brackets. I call my invention (TAB) for short. I claim that my brackets are my own design and this design can be modified to ensure a quality product by Federal and State rules and guidelines. I have researched and developed this tool and hereby obtain sole purpose of this object. I want full rights of protection from any other individuals, groups, organizations, etc. from designing or manufacturing such product.
These slotted brackets are made to the material design of trailers that are used to tow behind vehicles. My brackets, when installed on any typed of trailer can be adjusted to ensure exact alignment of the axles and wheels. My invention does save on tire wear, saves fuel of the tow vehicle and give a positive unmearsureable safety factor in the towing operation of any trailer. I do not know anyone who has this idea or design. Thank you
